(19) United States
(12) Patent Application Publication
(10) Pub. No.: US 2015/0074010 A1
(43) Pub. Date: Mar. 12, 2015

(54) NFC ENABLED CHARITABLE VOLUNTEERING AND GIVING

(71) Applicant: Sofia Marie Sabella, Richardson, TX (US)

(72) Inventor: Sofia Marie Sabella, Richardson, TX (US)

(21) Appl. No.: 14/482,493

(22) Filed: Sep. 10, 2014

Related U.S. Application Data
(60) Provisional application No. 61/875,923, filed on Sep. 10, 2013.

(51) Int. Cl. G06Q 30/02; H04B 5/00

(52) U.S. Cl. CPC G06Q 30/0279; H04B 5/0031
USPC 705/329

(57) ABSTRACT

A method of using near field communication to facilitate charitable giving and volunteering. The method includes the steps of: determining, by a computing device, information about a person and information about a charitable organization based at least in part on reading a near field communication element; determining, by the computing device, whether the person desires to give to the charitable organization or to volunteer to help the charitable organization; sending, by the computing device, the information about the person to the charitable organization in an event that the person desires to volunteer to help the charitable organization; and sending, by the computing device, a donation to the charitable organization in an event that the person desires to give to the charitable organization. Also, computing devices that perform such methods.

### CROSS-REFERENCE TO RELATED APPLICATION

This application claims the benefit of U.S. Provisional Application No. 61/875,923 titled “NFC ENABLED CHARITABLE VOLUNTEERING AND GIVING” and filed 10 Sep. 2013 in the name of the same inventor as this non-provisional application.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND

The present disclosure generally relates to using near field communication to facilitate charitable giving and volunteering.

### SUMMARY

Aspects of the subject technology include a method of using near field communication to facilitate charitable giving and volunteering. The method includes the steps of: determining, by a computing device, information about a person and information about a charitable organization based at least in part on reading a near field communication element; determining, by the computing device, whether the person desires to give to the charitable organization or to volunteer to help the charitable organization; sending, by the computing device, the information about the person to the charitable organization in an event that the person desires to volunteer to help the charitable organization; and sending, by the computing device, a donation to the charitable organization in an event that the person desires to give to the charitable organization. Also, computing devices that perform such methods.

Aspects of the subject technology also include a computing device such as a mobile phone configured to perform the foregoing method.

This brief summary has been provided so that the nature of the invention may be understood quickly. A more complete understanding of the invention may be obtained by reference to the following description in connection with the attached drawings.

### BRIEF DESCRIPTION OF THE DRAWINGS

FIG. 1 shows an environment in which a computing device may be used in conjunction with near field communication to facilitate charitable giving and volunteering according to aspects of the subject technology.

FIG. 2 shows another environment in which a computing device may be used in conjunction with near field communication to facilitate charitable giving and volunteering according to aspects of the subject technology.

FIG. 3 shows a flow diagram for a process performed by a computing device to use near field communication to facilitate charitable giving and volunteering according to aspects of the subject technology.

### DETAILED DESCRIPTION OF THE INVENTION

U.S. Provisional Application No. 61/875,923 titled “NFC ENABLED CHARITABLE VOLUNTEERING AND GIVING” and filed 10 Sep. 2013 is hereby incorporated by reference as if fully set forth herein.

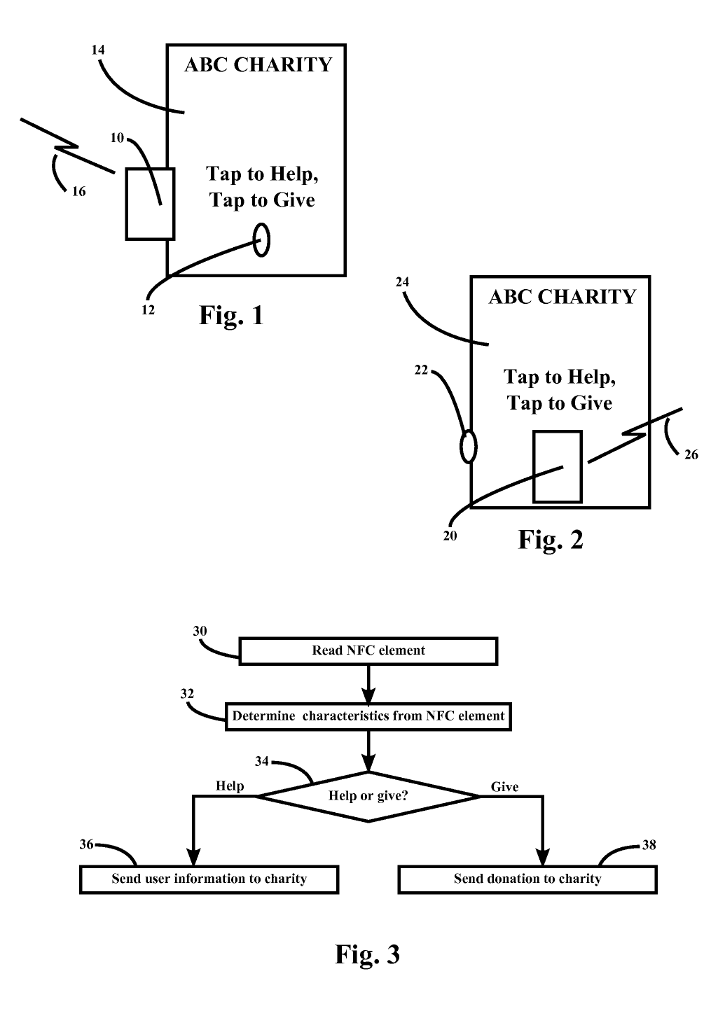

FIG. 1 shows an environment in which a computing device may be used in conjunction with near field communication to facilitate charitable giving and volunteering according to aspects of the subject technology. Computing device 10 is enabled to read near field communication element 12. Thus, computing device 10 includes at least one or more tangible computing elements, at least one memory that may store information instructions, and at least one near field communication receiver. Examples of computing device 10 include but are not limited to mobile computing devices such as phones, tablet computers, PDAs, and the like. An “app” or other program may be installed on the computing device to enable volunteering and/or donating to a charitable organization according to aspects of the subject technology.

Near field communication (i.e., NFC) element 12 is a type of radio frequency identifier (i.e., RFID) element that is designed to be readable at very short ranges such as a few centimeters. In FIG. 1, near field communication element 12 is attached to or part of charitable sign or display 14. The sign or display is illustrated as a poster identifying a charitable organization and including the instruction “Tap to Help, Tap to Give.” Alternatively, near field communication element 12 may be associated with a charitable organization in some other manner, for example by being included on or in a product that is used to fund raise for the charitable organization or in some other way. An example of such a product is the ubiquitous charity wristband that comes in various colors associated with various charitably organizations.

In some aspects, the near field communication element includes data representing characteristics of the charitable organization. For example, the near field communication element may include data representing the name of the charitable organization, a website or portal for the charitable organization, and/or the like. When the near field communication element is read, some or all of this data may be passed to the reading device such as computing device 10.

Computing device 10 in FIG. 1 may use the data read from a near field communication element to enable volunteering and/or donating to the charitable organization. For example, information about a user of the computing device may be sent to the charitable organization's website or portal if the person desires to volunteer to help the charitable organization. For another example, computing device may send a donation from the person to the charitable organization via the website or portal. The information and/or donation may be made over wireless link 16, which may be a wireless phone network link, a WiFi link, or any other wireless link. Alternatively, the information and/or donation may be placed over a wired connection to another computing device, possibly at a later time when such a connection becomes available.

FIG. 2 shows another environment in which a computing device may be used in conjunction with near field communication to facilitate charitable giving and volunteering according to aspects of the subject technology. Computing device 20, which may be a mobile computing device, is enabled to read near field communication element 22. Thus, computing device 20 includes at least one or more tangible computing elements, at least one memory that may store information instructions, and at least one near field communication receiver. Examples of computing device 20 include but are not limited to mobile phones, tablet computers, PDAs, point of sale (POS) systems, and the like.

In FIG. 2, computing device 20 is attached to or part of charitable sign or display 24. The sign or display is illustrated as a poster identifying a charitable organization and including the instruction “Tap to Help, Tap to Give.” Alternatively, computing device 20 may be associated with a charitable organization in some other manner, for example by being included on or in a product that is used to fund raise for the charitable organization, being in a location associated with the charitable organization, or in some other way.

Near field communication (i.e., NFC) element 22 is a type of radio frequency identifier (i.e., RFID) element that is designed to be readable at very short ranges such as a few centimeters. In some aspects, the near field communication element is associated with a person. For example, the near field communication element may include data representing the name and address of the person, be loaded with the person's payment information, and/or the like. The near field communication element may be included in an article worn by the person, for example a plastic or rubber wrist band.

Computing device 20 in FIG. 2 may use the data read from a near field communication element to enable volunteering or donating to the charitable organization. For example, information about the person associated with the near field communication element may be sent to the charitable organization's website or portal if the person desires to volunteer to help the charitable organization. For another example, computing device may send a donation from the person to the charitable organization via the website or portal. The information and/or donation may be made over wireless link 26, which may be a wireless phone network link, a WiFi link, or any other wireless link. Alternatively, the information and/or donation may be placed over a wired connection to another computing device, possibly at a later time when such a connection becomes available.

In other aspects, the near field communication device stores information about both a person and a charitable organization. Thus, in these aspects, the information stored in the near field communication element may be sufficient for a person to volunteer or to donate to a charitable organization by being read with a computing device that is not associated with a specific charitable organization.

FIG. 3 shows a flow diagram for a process performed by a computing device to use near field communication to facilitate charitable giving and volunteering according to aspects of the subject technology. This process may be performed by a computing device in an environment such as the one illustrated in FIGS. 1 and 2.

In step 30, a computing device reads a near field communication element, for example when a person “taps” such a near field communication element. In some aspects, the computing device may be associated with a person, and the near field communication element may be associated with a charitable organization. In other aspects, the computing device may be associated with a charitable organization, and the near field communication element may be associated with a person. In still other aspects, the near field communication element may be associated both with a person and with a charitable organization.

Sufficient information to permit the person to volunteer and/or donate to a charitable organization is determined in step 32. In some aspects, a computing device associated with a person combines information about that person with information about a charitable organization acquired in step 30. In other aspects, a computing device associated with a charitable organization combines information about that organization with information about a person acquired in step 30. In still other aspects, information about the person and the charitable information was acquired in step 30, and this information is determined.

The computing device determines in step 34 whether a person desires to give to the charitable organization or to volunteer to help the charitable organization (or both). The computing device may ask the person contemporaneously with reading the near field communication element, or a person's previous selection of helping or giving may be accessed. If the person desires to help the charitable organization (i.e., volunteer), flow proceeds to step 36. If the person desires to give to the charitable organization, flow proceeds to step 38.

In step 36, the computing device sends information about the person to the charitable organization, for example via a website or portal. In some aspects, this information is accessed from memory or some other source or acquired from the person. Examples of the information include but are not limited to the person's name and/or contact information provided by the person either contemporaneously or previously.

In step 38, the computing device is used to make a donation to the charitable organization, for example via a website or portal. In some aspects, the information necessary for donating to the charitable organization is accessed from memory or some other source or is acquired from the person. Examples of the information include but are not limited to payment information such as credit card information provided by the person either contemporaneously or previously.

The invention is in no way limited to the specifics of any particular embodiments and examples disclosed herein. For example, the terms “aspect,” “example,” “alternatively” and the like denote features that may be preferable but not essential to include in some embodiments of the invention. In addition, details shown or disclosed with respect to any one aspect of the invention may be used with other aspects of the invention. Additional elements may be added to various aspects of the invention and/or some disclosed elements may be subtracted from various aspects of the invention without departing from the scope of the invention. Singular items/steps imply plural items/steps and vice versa. Many other variations are possible which remain within the content, scope and spirit of the invention, and these variations would become clear to those skilled in the art after perusal of this application.

What is claimed is:

1. A method of using near field communication to facilitate charitable giving and volunteering, comprising the steps of:
determining, by a computing device, information about a person and information about a charitable organization based at least in part on reading a near field communication element;
determining, by the computing device, whether the person desires to give to the charitable organization or to volunteer to help the charitable organization;
sending, by the computing device, the information about the person to the charitable organization in an event that the person desires to volunteer to help the charitable organization; and
sending, by the computing device, a donation to the charitable organization in an event that the person desires to give to the charitable organization.

2. A method as in claim 1, wherein the computing device is associated with the person and the near field communication element is associated with the charitable organization.

3. A method as in claim 1, wherein the computing device is associated with the charitable organization and the near field communication element is associated with the person.

4. A method as in claim 1, wherein the computing device comprises a mobile computing device.

5. A method as in claim 1, wherein sending the information about the person to the charitable organization further comprises accessing or acquiring, by the computing device, contact information provided by the person.

6. A method as in claim 1, wherein sending a donation to the charitable organization further comprises accessing or acquiring, by the computing device, payment information provided by the person.

7. A computing device comprising:
one or more tangible computing elements; and
at least one memory storing instructions that, when executed by the one or more tangible computing elements, causes the computing device to perform steps including:
determining information about a person and information about a charitable organization based at least in part on reading a near field communication element;
determining whether the person desires to give to the charitable organization or to volunteer to help the charitable organization;
sending the information about the person to the charitable organization in an event that the person desires to volunteer to help the charitable organization; and
sending a donation to the charitable organization in an event that the person desires to give to the charitable organization.

8. A computing device as in claim 7, wherein the computing device is associated with the person and the near field communication element is associated with the charitable organization.

9. A computing device as in claim 7, wherein the computing device is associated with the charitable organization and the near field communication element is associated with the person.

10. A computing device as in claim 7, wherein the computing device comprises a mobile computing device.

11. A computing device as in claim 7, wherein sending the information about the person to the charitable organization further comprises accessing or acquiring, by the computing device, contact information provided by the person.

12. A computing device as in claim 7, wherein sending a donation to the charitable organization further comprises accessing or acquiring, by the computing device, payment information provided by the person.
